(19) United States
(12) Patent Application Publication
(10) Pub. No.: US 2016/0101389 A1
(43) Pub. Date: Apr. 14, 2016

(54) METHOD OF PERFORMING A CLEANING OPERATION ON A WATER FILTRATION DEVICE

(71) Applicant: H2O INNOVATION INC., Quebec (CA)

(72) Inventors: Denis Guibert, Burlington (CA); Bill Legge, Burlington (CA); Frederic Dugré, Quebec (CA); Paul Laverty, Vista, CA (US)

(21) Appl. No.: 14/878,589

(22) Filed: Oct. 8, 2015

Related U.S. Application Data
(60) Provisional application No. 62/061,303, filed on Oct. 8, 2014.
(60) Provisional application No. 62/203,489, filed on Aug. 11, 2015.

(51) Int. Cl. B01D 65/02; C02F 1/44

(52) U.S. Cl. CPC B01D 65/02; C02F 1/44; B01D 2321/02; B01D 2321/162; B01D 2321/40; B01D 2321/28; B01D 2321/205

(57) ABSTRACT

The method is used for performing a cleaning operation on a water filtration device having an inlet, a concentrate outlet, a permeate outlet, a filtration membrane between the inlet and the permeate outlet, the filtration membrane filtering water under pressure during a filtration operation of the water filtration device, and a recirculation line leading from at least one of the concentrate outlet and the permeate outlet back to the inlet. The method generally has a step of performing the cleaning operation including recirculating a solution along the recirculation line, the solution having at least water and one cleaning agent, the step of recirculating including maintaining a circulation of the solution along the entire length of the recirculation line.

### CROSS-REFERENCE TO RELATED APPLICATIONS

This patent application claims priority of US provisional Application Ser. No. 62/061,303, filed on Oct. 8, 2014, and of US provisional Application Ser. No. 62/203,489, filed on Aug. 11, 2015, the contents of which are hereby incorporated by reference.

### BACKGROUND

Many water filtration systems, such as some found in drinking water production, industrial applications, or wastewater treatment systems for instance, are pressurized and immersed membrane systems which require regular cleaning. Such systems have relied for decades on a “Clean-in-place” (CIP) cleaning principle involving a CIP tank, a recirculation pump, valves and other associated equipment. An example of such a cleaning system 100 is shown in FIG. 1, where the valves are not shown for simplicity. During normal operation of the membrane, feed water is fed into a membrane filter 101 (the membrane of which can be a microfiltration membrane, an ultrafiltration membrane, a nanofiltration membrane or a reverse osmosis membrane, depending on the application) where the water is filtered by permeating through the filter 101. The filtered water is outputted from the membrane filter 101 through an outlet (or a plurality of outlets) referred to as the filtrate outlet 103, and the material rejected by the membrane filter 101 is outputted from an outlet referred to as the concentrate outlet 105.

The CIP cleaning principle involved filling a CIP tank 107, and then closing a cleaning loop 109 using valves (not shown). A cleaning agent 111 was added to the water. Then, the cleaning cycle could commence by activation of the recirculation pump 113 which pumped the water and the cleaning agent 111 into the membrane filter 101 and back into the CIP tank 107. This process could be used either with permeate-side cleaning, in which case the water and the cleaning agent 111 were circulated across the membrane filter 101, out the filtrate outlet 103 and back into the tank 107; or with concentrate-side cleaning, in which case the water and the cleaning agent 111 were circulated along the membrane filter 101, out a concentrate outlet 105 and back into the tank 107. The existing CIP cleaning principle is performed with a set amount of chemicals.

The CIP cleaning principle then involved disposing of the water and the cleaning agent, considered wastewater at this stage. In many applications, it was required to neutralize the wastewater prior to disposing of it. This typically involved manually measuring characteristics of the wastewater in the tank 107 (e.g. pH, Chlorine, ORP, etc) and adding a satisfactory quantity of the neutralizing agent 115 prior to disposing of the wastewater. A mixing line 117 was provided in some systems to recirculate the neutralizing agent 115 directly back into the tank 107 in order to mix the neutralizing agent 115 with the water prior to disposal.

Although this CIP cleaning principle was satisfactory to a certain degree, there remains room for improvement. In particular, the CIP tank 107 represented a significant amount of hardware and volume, which translated into initial costs and sheltering costs.

### SUMMARY

It was found that the CIP tank could be avoided altogether. In one aspect, a closed recirculation line is used instead of the CIP tank. The cleaning operation can be performed by circulating a cleaning agent mixed into the water held in the filtration device and the recirculation line for a given period of time, and then disposing of the solution. Parameters of the solution can even be monitored during the circulation along the circuit formed by the recirculation line and filtration device, and cleaning agent can be added in real time as needed. Similarly, the disposal of the solution can be performed via a disposal line in which parameters of the solution are monitored and one or more neutralization agents are injected in real time, in a manner to neutralize the solution as it progresses along the disposal line and prior to its evacuation to waste.

In accordance with one aspect, there is provided a method of performing a cleaning operation on a water filtration device having an inlet, a concentrate outlet, a permeate outlet, a filtration membrane between the inlet and the permeate outlet, the filtration membrane filtering water under pressure during a filtration operation of the water filtration device and a recirculation line leading from at least one of the concentrate outlet and the permeate outlet back to the inlet, the method comprising: performing the cleaning operation including recirculating a solution along the recirculation line, the solution having at least water and one cleaning agent, the step of recirculating including maintaining a circulation of the solution along the entire length of the recirculation line.

In accordance with another aspect, there is provided a water filtration system having a membrane filter, the membrane filter having an inlet and at least one outlet, the water filtration system having a tankless recirculation line leading from the at least one outlet of the membrane filter back to the inlet of the membrane filter, the water filtration system having a pump in the tankless recirculation line, the pump being operable to recirculate liquid along the tankless recirculation line and across the membrane filter.

Many further features and combinations thereof concerning the present improvements will appear to those skilled in the art following a reading of the instant disclosure.

### DESCRIPTION OF THE FIGURES

In the figures,

FIG. 1 is a schematic view of an example of a membrane filtration device with a cleaning system in accordance with the prior art; and

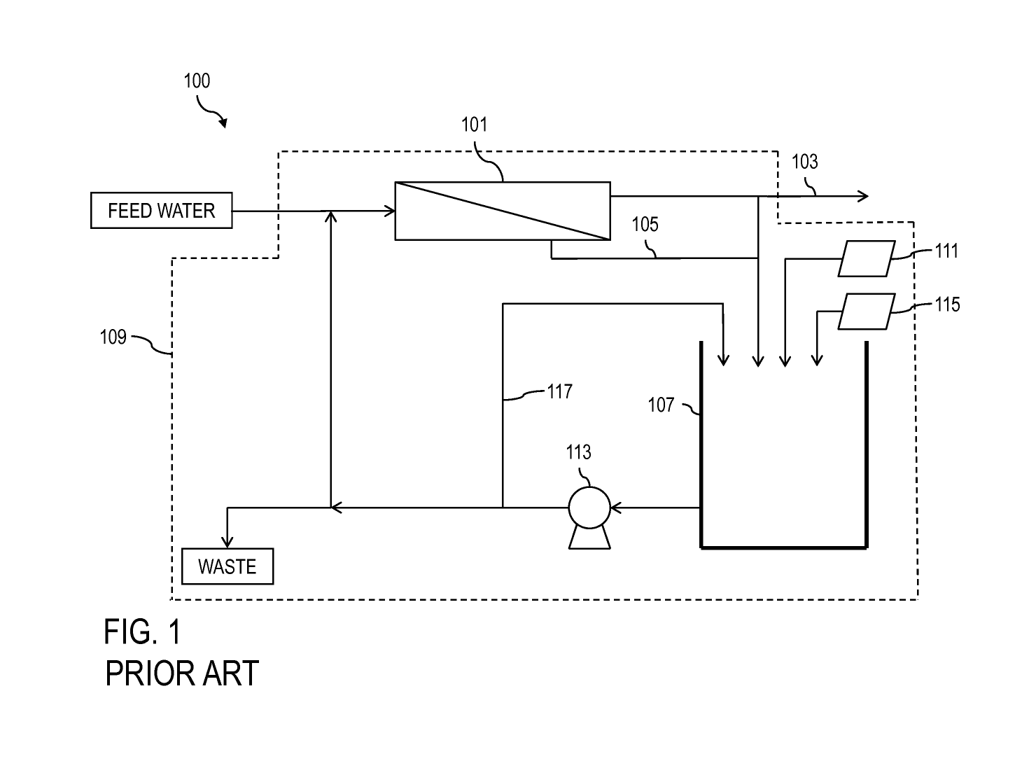

FIG. 2 is a schematic view of an example of a membrane filtration device with a cleaning system in accordance with the specification.

### DETAILED DESCRIPTION

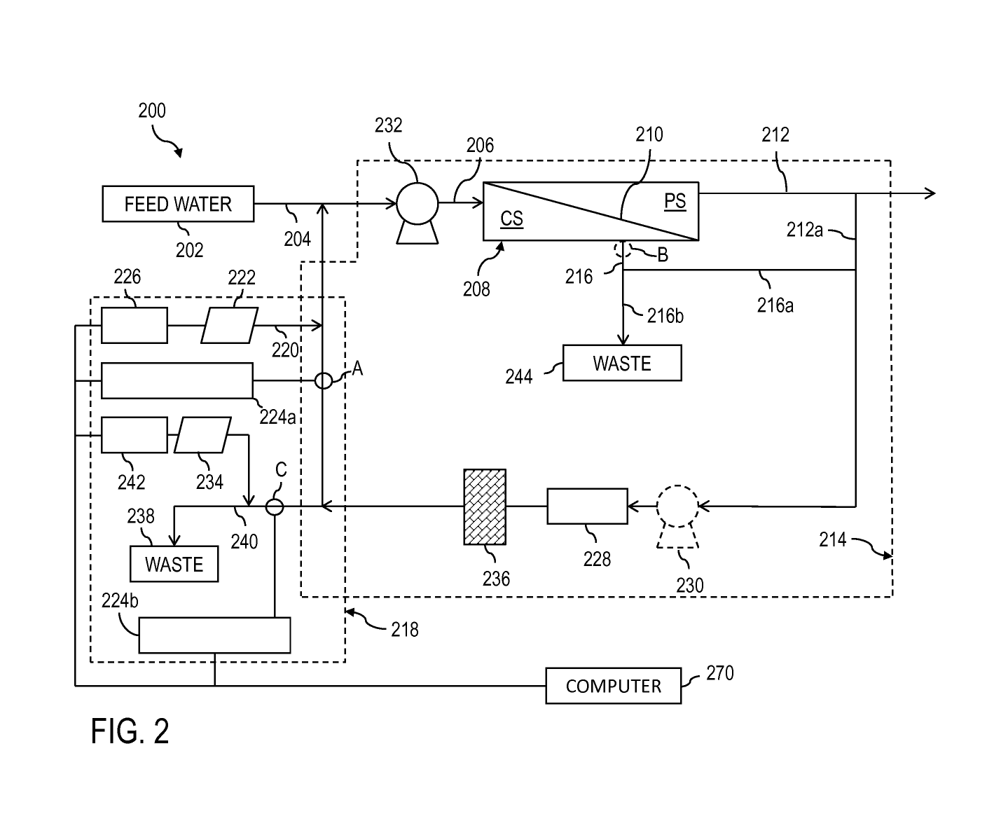

FIG. 2 shows an example of a system 200 of performing a cleaning operation which can be automated and which avoids the use of a CIP tank altogether. The membrane filtration system 200 includes a feed water source 202 which is provided, via a feed line 204, to an inlet 206 of a membrane filtration device 208 which filters based on a pressure differential across a membrane 210. The membrane 210 can be a microfiltration membrane, an ultrafiltration membrane, a nanofiltration membrane or a reverse osmosis membrane, for instance. The membrane filtration device 208 has a filtrate outlet 212 from which filtered water is extracted during regular filtration operation of the system 200. The membrane filtration device 208 has an outlet 216 from which concentrate is extracted and directed to a waste 244 via a concentrate conduit 216a.

The membrane filtration system 200 also includes a cleaning recirculation line 214, which is generally provided in the form of one or more conduits connected in series. The recirculation line 214 can generally be said to recirculate liquid from the outlet 216 of the membrane filtration device 208 to an inlet thereof (e.g. the inlet 206) via a liquid outlet 216b, and includes a cleaning subsystem 218 having a cleaning agent feed aperture or inlet 220 leading into the recirculation line 214 of liquid to feed a cleaning agent 222 directly in-line, into the recirculating liquid. The recirculation line 214 is used to circulate, and to maintain circulation, of a cleaning solution along the entire length of the recirculation line 214, i.e. along the outlets 212 and/or 216 and their corresponding conduits 212a and/or 216a back to the inlet 206 and across the membrane filtration device 208. In this embodiment, the recirculation line 214 is provided in the form of a closed series of conduits connected to the membrane filtration device 208 (i.e. the recirculation line is tankless recirculation line, it does not have a CIP tank open to the atmosphere). A monitoring device 224a can be used to measure the concentration of the cleaning agent 222 and other analytical parameters in the recirculating liquid and to control a cleaning agent feeding system 226 accordingly. In this embodiment, the monitoring device 224a performs monitoring in a conduit of the recirculation line 214. During the cleaning operation of the system 200, the recirculation line 214 is closed off from the rest of the system 200 (e.g. feed water source 202 and filtrate outlet line(s) 212) using valves which are not shown here for simplicity, and the recirculation of the liquid, including the cleaning agent 222, (i.e. the cleaning solution) can be performed for a given amount of time which can be determined based on the specific application or on characteristics of the recirculated liquid which are monitored (e.g. contaminant concentration) by the monitoring device 224a. It will be understood that, in an alternate embodiment, the cleaning agent 222 can be added to the recirculation line 214 prior to circulation of the feed water along the recirculation line 214. Depending on the application, the monitoring device 224a can be positioned at different positions along the recirculation line 214. In the embodiment shown in FIG. 2, the monitoring device 224a is positioned between the outlet 216 and the inlet 206 at position A. In another embodiment, the monitoring device 224a is positioned directly next to the membrane filtration device 208 at position B, thus allowing a faster response time and faster tuning of the cleaning operation.

As illustrated, the system 200 has a computer 270 which is configured to communicate (e.g. via Internet, a wired connection and/or a wireless connection) with the monitoring device 224a and with the cleaning agent feeding system 226. Upon reception of an input from the monitoring device 224, the computer 270 is configured to transmit instructions towards the cleaning agent feeding system 226 regarding feeding of the cleaning agent 222 in the recirculation line 240. The computer 270 is not limited to be on site such that monitoring of the parameter(s) can be made from a remote location. Although a single computer 270 is shown, it is understood that more than one computer can be used. For instance, in another embodiment, each of the monitoring device 224a and the cleaning agent feeding system 226 is connected to a processing unit (e.g. having a processor, a computer-readable memory and a transmitter). In this embodiment, the processing unit of the monitoring device 224a sends data regarding the monitored parameter(s) towards the computer 270 which then transmits instructions to the cleaning agent feeding system 226.

Depending on the application and the type of membrane, the cleaning operation can either be a concentrate-side (CS) cleaning operation or a permeate-side (PS) cleaning operation. The concentrate-side cleaning operation typically involves recirculating the liquid against the membrane 210, but not across it, and extracting the liquid from the concentrate outlet 216 of the membrane filtration device 208 (as opposed to the filtrate outlet 212 which is typically separated from the inlet 206 by the membrane 210). The permeate-side cleaning operation rather involves circulating the pressurized liquid across the membrane 210 and out the filtrate outlet 212. In many applications, the type of cleaning operation does not significantly affect the remainder of the cleaning process. The recirculating of the fluid can be continuous, or can consist of episodes of recirculation separated by periods of inactivity of “soaking” of the membrane and other components. Moreover, the cleaning process can be divided into sub steps such that the cleaning of the membranes can occur throughout several cycles. For instance, a first batch of solution can be recirculated and discharged, followed by a second batch and so on.

In some applications, rather than proceeding in batches, it may be required to continuously bring fresh cleaning solution while continuously wasting cleaning solution as well to manage the concentration of suspended solids within the system and enhance the cleaning efficiency. The waste discharge would then be throttled to bleed the cleaning waste while the cleaning solution is being recirculated.

In some applications, especially when the water is cold, it can be required to heat the liquid to achieve a satisfactory cleaning efficiency. In this embodiment, a heater 228 can be added in-line to progressively increase the temperature of the liquid as it recirculates. The heater 228 can be provided on the suction or discharge piping of the cleaning pump, for instance.

In the illustrated embodiment, a dedicated recirculation pump 230 is shown in conjunction with a feed pump 232. In alternate embodiments, the feed water pump 232 can be used instead of the dedicated recirculation pump 230 to save equipment and footprint.

In the illustrated embodiment, the ability to monitor the cleaning progression (i.e. the cleaning status) in real time is achieved by recording analytical measurements of the recirculated stream. By not having a large CIP tank, the measurements are not buffered or diluted and provide a much more accurate assessment of the cleaning progress. Chemical composition changes are recorded faster and allow more accurate controls. The composition of the cleaning solution can be adjusted in real time thanks to these measurements and provide greater cleaning performance.

In an embodiment, the cleaning operation can be initiated when it is determined that the membrane 210 has a fouling layer (clogged matter on the CS of the membrane 210). The presence of at least a portion of a fouling layer can be determined by the measurement of a feed pressure increase, a flow variation or a permeate quality variation, for example.

By monitoring, in real time, parameters of the cleaning solution in the recirculation line 214 using the monitoring device 224a, the system 200 can adjust the cleaning operation reactively. Examples of parameters that can be monitored are pH, color, oxidation reduction potential (ORP), hardness via measurement of an amount of unwanted material accumulated on the membrane 210 (e.g. fouling), temperature, streaming current, presence of organic carbon via absorption of UV light (at 254 nm), concentration of the cleaning agent 222 and the like. There can be other parameters. It is understood that the cleaning agent 222 can be a premixed solution of agents such as acids, bases, surfactants, sequestrants to remove clogging matter (e.g. Lavasol 1, Lavasol 7), bactericides to kill bacteria and silica cleaning agents. The cleaning agent 222 can have one or more agents. However, providing a single agent in the cleaning agent in a given cleaning cycle can be preferred since it can allow for easier analysis of the cleaning operation, and therefore, easier determination of the subsequent cleaning cycles to be performed. For instance, if it is determined that the fouling layer has calcium carbonate, using an acid-based cleaning cycle can be appropriate. If it is determined that the fouling layer has organic matter, another type of cleaning cycle (e.g. using surfactants) can be more appropriate. The type of cleaning cycle which is to be performed depends on the application. Accordingly, the following paragraphs describe some examples of types of cleaning cycle which can be used by the system 200.

In an embodiment, a cleaning operation can involve addition of a given amount of a cleaning agent having an acid agent, which will be referred to as the “acid cleaning cycle”. In this embodiment, once the acid cleaning cycle has been initiated, the system 200 can be configured to monitor a pH value (i.e. perform a series of pH value measurements distributed over time) of the recirculation line 214. An increase in the pH value over time can be an indication that the cleaning operation works satisfactorily. If the pH value does not vary upon addition of the given amount of cleaning agent over a given period of time, the system 200 can iteratively add additional quantities of cleaning agent. The acid cleaning cycle can be maintained once a given pH threshold is reached. The acid cleaning cycle can be stopped when a variation of the pH value between successive pH measurements stay relatively constant. It is noted that a decrease in the pH value over time can be an indication that the cleaning solution is oversaturated. In this case, the system 200 can initiate another acid cleaning cycle or alternatively determine that the acid cleaning cycle is not well suited for the system 200. A neutral cleaning cycle and/or a base cleaning cycle can alternately be used, depending on the circumstances.

In another embodiment, the cleaning operation can involve addition of a cleaning agent having a base agent, which will be referred to as the “base cleaning cycle”. It will be understood that the base cleaning cycle is to be performed in a similar manner (although the pH value is different, and the pH variation is opposite) than the acid cleaning cycle as described herein. Further, the recirculation line 214 can be made separate to maintain the temperature of the cleaning solution in a temperature operation range.

In another embodiment, the cleaning operation can involve addition of a given amount of a cleaning agent having a neutral agent (e.g. a dispersant, a surfactant or a combination thereof), which will be referred to as the “neutral agent cycle”. The neutral agent cycle tends to remove hydrocarbons, bacteria and bacteria generated matter. The monitoring device 224a can be used to monitor an organic matter concentration. When the monitored organic matter concentration stays relatively constant, the neutral agent cycle can be deemed not well suited to remove organic matter from the membrane 210 anymore and another cleaning cycle can be performed.

In another embodiment, the cleaning operation can involve monitoring of the color of the cleaning solution circulating in the recirculation line 214. When the color of the cleaning solution in the recirculation line 214 changes to a predetermined color or stops varying in tone, the status of the cleaning operation can be determined. In this case, the cleaning operation can be stopped or another cleaning cycle can be initiated depending on the status of the cleaning operation.

In another embodiment, the cleaning operation can involve addition of a given amount of a cleaning agent having a reducing agent (e.g. sodium bisulfite and/or other reducing agents), which will be referred to as the “reducing agent cycle”. In this embodiment, the monitoring device 224a can be used for monitoring an ORP value of the cleaning solution (in this case the ORP value is a negative value). In this embodiment, monitoring the ORP value, after or during addition of the cleaning agent, can help determining if the cleaning solution has an appropriate ORP value when the ORP value reaches a given ORP negative threshold.

In another embodiment, the cleaning operation involves addition of a cleaning agent having a oxydative agent, which will be referred to as the “oxidative cleaning cycle”. In a similar manner than for the reducing agent cycle, measurement of the ORP value by the monitoring device 224a can help determining if addition of oxydative agent is appropriate or if the oxydative cleaning cycle is done. In this case, the ORP value is a positive value. The oxydative cleaning cycle is deemed to be done when the ORP value reaches a given ORP positive threshold.

In another embodiment, the cleaning operation includes monitoring of an hardness value via the measurement of the amount of unwanted material accumulated on the membrane 210 distributed over time.

In another embodiment, the cleaning operation includes monitoring of a streaming current indicating the electrostatic charge of the matter unclogged from the membrane 210 using the monitoring device 224a. More specifically, an optimal electrostatic charge of the clogged matter/fouling layer (e.g. calcium carbonate) at which the unclogging of the fouling layer is appropriate can be determined. Thereafter, maintaining a pH value of the cleaning solution in order for the fouling layer to be maintained at the optical electrostatic charge can help the cleaning operation. Accordingly, the system 200 can determine if the pH value is to be increased or decreased to maintain the electrostatic charge of the unclogged matter in the range of the optimal electrostatic charge.

In an embodiment, the recirculation line 214 has a volume of 200 gallons, which is considerably smaller than that of a CIP tank and its associated piping. The reduced volume of the recirculation line 214 allows for smaller cleaning cycles which can be performed one or many times (1, 2, 4-5 times) depending on the fouling layer. Indeed, a fouling layer that is more dirty will require more cleaning cycles than a fouling layer that is less dirty, which will require a lesser number of cleaning cycles.

After the cleaning operation has been performed to a satisfactory extent, the cleaning solution can be disposed of by flowing it to waste 238 (or by recycling it) via a disposal line 240. In the illustrated embodiment, flowing is achieved by operating the valves (not shown for simplicity) in a manner that the membrane filtration device 208 is fed with feed water or filtrate and that the resulting solution is flowed along the disposal line 240 (note: some alternate embodiments can recycle the cleaning solution by storing it inside a separate system for further use, such as processing through another filter, for instance). In the illustrated embodiment, this “rinsing” mode of operation is performed for a given amount of time considered sufficient to reduce any contaminant stemming from the cleaning operation in the filtrate to an acceptable level.

The disposal of cleaning solution or rinsing water can require treatment such as neutralization in some embodiments, which can, as illustrated, be performed directly in the disposal line 240. The neutralizing operation is generally performed in line so that use of a separate tank or a CIP tank is avoided. Neutralizing the cleaning solution that is to be dumped into the waste 238 as a neutralized solution is performed in line to save space, equipment and the like. The neutralizing operation requires that the neutralized solution be environmentally secure. In order for the neutralized solution to be suitably neutralized, the monitoring device 224b can be used to monitor the pH value of the neutralized solution as well as the ORP value (and other parameters deemed suitable). It will be understood that the addition of the neutralizing agent 234 is performed along a disposal line 240 which is outside the recirculation line 214 since contact between the neutralizing agent 232 and the membrane 210 is likely to cause clogging and thus generates problems. Neutralization of the cleaning solution is thus performed along the disposal line 240 exiting from the recirculation line 214 and leading to the waste 238. This neutralization step is optional

In the embodiment shown, the neutralization of the cleaning solution is performed in-line during flowing of the cleaning solution along the disposal line 240 using a neutralizing agent feed system having a dosing pump 242 and the computer 270. In this embodiment, the computer 270 is connected to the dosing pump 242 and to the monitoring device 224b in a wired or wireless fashion for transmittal of data and instructions. Moreover, in the illustrated embodiment, the neutralizing agent feed system includes an on-line monitoring device 224b which monitors parameter(s) of the liquid in order to determine how much, and potentially which, neutralizing agent(s) 234 must be fed and mixed into the liquid in the disposal line for the wastewater to be considered in a satisfactory condition for disposal in the waste 238. More specifically, the neutralization is performed by adding a flow of the neutralizing agent 234 to the flow of the liquid flowing along the disposal line 240. Examples of parameters that can be monitored by the monitoring device 224b include a pH value, ORP value, flow rate and/or concentration of the liquid in the disposal line 240. In the embodiment shown, the disposal line is positioned at dosing pump connection C, upstream relative to said monitoring, such that the parameters be determined prior to adding the neutralizing agent 234 along the disposal line 240. Such monitoring allows to determine a given flow rate (e.g. order of ml/min) of neutralizing agent 234 to be added to the cleaning solution in order to neutralize the cleaning solution prior to disposal in the waste 238. In an embodiment, when the cleaning solution has a pH value of 2 as measured by the monitoring device 224b, the neutralizing agent 234 can be added to the cleaning solution to form the neutralized solution. In an embodiment, the cleaning solution is considered to be neutralized when the pH value is between 6 and 8. As will be understood, in this embodiment, only a portion of the cleaning solution circulating along the recirculation line 214 is flowed through the disposal line 240. This neutralization step can be performed simultaneously to the cleaning operation.

In the illustrated embodiment, one or more cartridge filters 236 are used to capture the matter dislodged from the membrane surface 210 during the cleaning. In alternate embodiments, the filters 236 can be eliminated to further save equipment.

As can be understood, the examples described above and illustrated are intended to be exemplary only. For instance, in alternate embodiments, the membrane filtration device can have more than one inlet, more than one membrane more than one outlet, and one or more of the inlets and outlets can be used during the recirculation step. The scope is indicated by the appended claims.

What is claimed is:

1. A method of performing a cleaning operation on a water filtration device having an inlet, a concentrate outlet, a permeate outlet, a filtration membrane between the inlet and the permeate outlet, the filtration membrane filtering water under pressure during a filtration operation of the water filtration device, and a recirculation line leading from at least one of the concentrate outlet and the permeate outlet back to the inlet, the method comprising:
performing the cleaning operation including recirculating a solution along the recirculation line, the solution having at least water and a cleaning agent, the step of recirculating including maintaining a circulation of the solution along the entire length of the recirculation line.

2. The method of claim 1 further comprising monitoring at least one parameter of the solution at one or more positions along the length of the recirculation line during said recirculating.

3. The method of claim 2 further comprising heating the solution during said recirculating based on said monitoring.

4. The method of claim 2, wherein the at least one parameter includes at least one of a composition, a pH value, an oxidation reduction potential value, a color, a hardness, a streaming current, an organic matter concentration and a temperature of the solution.

5. The method of claim 2 further comprising adding the cleaning agent to the recirculation line based on said monitoring.

6. The method of claim 5 wherein said adding is performed simultaneously to said recirculating.

7. The method of claim 1 further comprising flowing at least a portion of the solution out of the recirculation line, along a disposal line, and to waste.

8. The method of claim 7 wherein said flowing is performed subsequently to said recirculating.

9. The method of claim 7 wherein said flowing further includes neutralizing the solution by adding a flow of at least one neutralizing agent to the flow of the at least a portion of the solution in the disposal line.

10. The method of claim 9 further comprising a step of monitoring at least one parameter of the at least a portion of the solution in the disposal line, wherein a flow rate of the flow of the at least one neutralizing agent is based on the step of monitoring.

11. The method of claim 10 wherein said monitoring in the disposal line is performed upstream from said neutralizing.

12. The method of claim 10 wherein the at least one parameter includes at least one of the flow rate, a pH value and an oxidation reduction potential value.

13. The method of claim 1 further comprising circulating feed water to the recirculation line via the inlet during said recirculating.

14. The method of claim 1 wherein said performing the cleaning operation further comprises stopping said recirculating and soaking the filtration membrane for a given period of time and then resuming said recirculating.

15. The method of claim 1 wherein the recirculation line is closed during said recirculating.

16. A water filtration system having a membrane filter, the membrane filter having an inlet and at least one outlet, the water filtration system having a tankless recirculation line leading from the at least one outlet of the membrane filter back to the inlet of the membrane filter, the water filtration system having a pump in the tankless recirculation line, the pump being operable to recirculate liquid along the tankless recirculation line and across the membrane filter.

17. The water filtration system of claim 16 comprising a cleaning agent feed system operable to feed at least one cleaning agent into the liquid.

18. The water filtration system of claim 17 further comprising a monitoring device operable to monitor at least one parameter of the liquid and a computer configured to operate the cleaning agent feed system based on an input from the monitoring device.

19. The water filtration system of claim 16 wherein the tankless recirculation line has a disposal line leading out of the tankless recirculation line, the water filtration system further comprising neutralizing agent feed system having a dosing pump connected to the disposal line via a dosing pump connection, a monitoring device upstream of the dosing pump connection and a computer configured to operate the dosing pump based on an input from the monitoring device.

20. The water filtration system of claim 16 wherein the tankless recirculation line has one or more filters to capture the matter being cleaned off a surface of the membrane filter during said cleaning operation.
